(19) United States
(12) Patent Application Publication
(10) Pub. No.: US 2024/0242142 A1
(43) Pub. Date: Jul. 18, 2024

(54) SYSTEMS AND METHODS FOR DATA EXTRACTION AND AUTOMATIC MATTER ASSIGNMENT

(71) Applicant: RELX Inc., Miamisburg, OH (US)

(72) Inventors: Amanda Mostafavi, Miamisburg, OH (US); Joseph Hunt, Miamisburg, OH (US)

(73) Assignee: RELX Inc., Miamisburg, OH (US)

(21) Appl. No.: 18/411,944

(22) Filed: Jan. 12, 2024

Related U.S. Application Data
(60) Provisional application No. 63/479,696, filed on Jan. 12, 2023.
(60) Provisional application No. 63/479,699, filed on Jan. 12, 2023.
(60) Provisional application No. 63/479,701, filed on Jan. 12, 2023.

(51) Int. Cl. G06Q 10/0631; G06F 40/40; G06Q 50/18

(52) U.S. Cl. CPC G06Q 10/063112; G06F 40/40; G06Q 50/18

(57) ABSTRACT

In one embodiment, a method of automatically assigning a matter includes receiving matter information, generating one or more new matter vectors from the matter information, comparing the one or more new matter vectors to historical matter vectors of historical matter information relating to historical matters, selecting a plurality of historical matters from the historical matters, where each historical matter of the plurality of historical matters has a similarity between the one or more new matter vectors and one or more historical matter vectors that is above a threshold, determining a subset of employees associated with the plurality of historical matters, where the subset of employees is a subset of a plurality of employees, applying one or more rules to the subset of employees to generate a score for each employee of the subset of employees, and assigning the matter to an assigned employee having a highest score.

### CROSS-REFERENCE TO RELATED APPLICATIONS

This application claims priority to U.S. Provisional Application No. 63/479,696 filed on Jan. 12, 2023 and entitled “Automatic Matter Intake Form Suggestion at Time of Matter Request Creation,” U.S. Provisional Application No. 63/479,699 filed on Jan. 12, 2023 and “Automatic Matter Creation from Emails,” and U.S. Provisional Application No. 63/479,701 filed on Jan. 12, 2023 and entitled “People Recommendation and Auto Assignment,” all of which are incorporated by reference in their entireties.

### BACKGROUND

In many industries, new work projects come into an organization where they are assigned a matter. These matters are staffed by employees or other personnel to complete the requirements of the matter. In the legal field, a new litigation may come into a law firm that needs to be staffed by proper attorneys. Typically, the attorneys that are staffed to a litigation matter have experience with the type of litigation and have the skills that are required. However, particularly in large organizations, it can be difficult to properly match the correct employees with the correct new matters that come into the organization.

Accordingly, alternative systems and methods for assigning employees to matters may be desired.

### BRIEF SUMMARY

In one embodiment, a method of automatically assigning a matter includes receiving, by one or more processors, matter information, generating one or more new matter vectors from the matter information, comparing the one or more new matter vectors to historical matter vectors of historical matter information relating to historical matters, selecting a plurality of historical matters from the historical matters, where each historical matter of the plurality of historical matters has a similarity between the one or more new matter vectors and one or more historical matter vectors that is above a threshold, determining a subset of employees associated with the plurality of historical matters, where the subset of employees is a subset of a plurality of employees, applying one or more rules to the subset of employees to generate a score for each employee of the subset of employees, and assigning the matter to an assigned employee having a highest score.

In another embodiment, a system for assigning a matter includes one or more processors. The system also includes a memory storing instructions that, when executed by the one or more processors, configure the one or more processors to receive matter information, generate one or more new matter vectors from the matter information, compare the one or more new matter vectors to historical matter vectors of historical matter information relating to historical matters, select a plurality of historical matters from the historical matters, where each historical matter of the plurality of historical matters has a similarity between the one or more new matter vectors and one or more historical matter vectors that is above a threshold, determine a subset of employees associated with the plurality of historical matters, where the subset of employees is a subset of a plurality of employees, apply one or more rules to the subset of employees to generate a score for each employee of the subset of employees, and assign the matter to an assigned employee having a highest score.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example system for automatically completing matter intake forms according to one or more embodiments described and illustrated herein.

FIG. 2 illustrates an example graphical user interface for automatically completing matter intake forms according to one or more embodiments described and illustrated herein.

FIG. 3 illustrates an example system for automatically classifying a matter according to one or more embodiments described and illustrated herein.

FIG. 4 illustrates an example system for automatically completing one or more matter intake forms according to one or more embodiments described and illustrated herein.

FIG. 5 illustrates a flowchart of an example method for automatically completing one or more matter intake forms according to one or more embodiments described and illustrated herein.

FIG. 6 illustrates an example system for assigning an employee to a matter according to one or more embodiments described and illustrated herein.

FIG. 7 illustrates a flowchart of an example method for automatically assigning an employee to a matter according to one or more embodiments described and illustrated herein.

FIG. 8 illustrates an example computing system for automatically completing one or more matter intake forms according to one or more embodiments described and illustrated herein.

### DETAILED DESCRIPTION

Embodiments of the present disclosure are directed to systems and methods for automatically assigning a matter (e.g., a work project) by extracting data from electronic matter information and comparing that extracted information with historical matters to select the optimal employee to handle the matter. Upon the creation of a matter, the associated matter information is analyzed along with current employee workloads and other factors to determine who is best suited to completing the matter.

As described in more detail below, once the new matter is created in a central tracking system (e.g., a docketing system), the system can also send an automatic response to the requestor, pointing them to the created matter and providing any necessary information or instructions. This helps streamline the matter request process and makes it more efficient for all parties involved. These systems and methods allow for easier management and tracking of matters which are submitted via email. Embodiments of the present disclosure may be used to automatically assign matters to any type of employee, such as an attorney, a technician, a developer, an engineer, and the like.

In some embodiments, the system automatically classifies a matter type of a new incoming matter, and automatically completes one or more matter intake forms based on the matter type upon matter intake. Generally, such embodiments include receiving input data regarding a new matter, and automatically classifying the new matter into a matter classification based on the input data. One or more matter intake forms are selected based on the matter classification. Field data is then automatically extracted from the input data and populated into relevant fields of the one or more matter intake forms. The matter intake forms can then be used for downstream processes.

By automatically classifying the matter and auto-populating the fields of the relevant matter intake form(s), significant time and resources are saved. Personnel can instead perform other tasks.

Various embodiments of systems and methods for automatically assigning matters are described in more detail below.

Although embodiments are described herein in the context of the legal field, embodiments are not limited thereto. Embodiments may be utilized in any field where matters are assigned used, such as medical, construction, interior design, web design, consulting, and the like.

As stated above, in some embodiments, matters are automatically classified and/or matter intake forms are automatically completed. In other embodiments, the new matters are not automatically classified and/or matter intake forms are manually filled out.

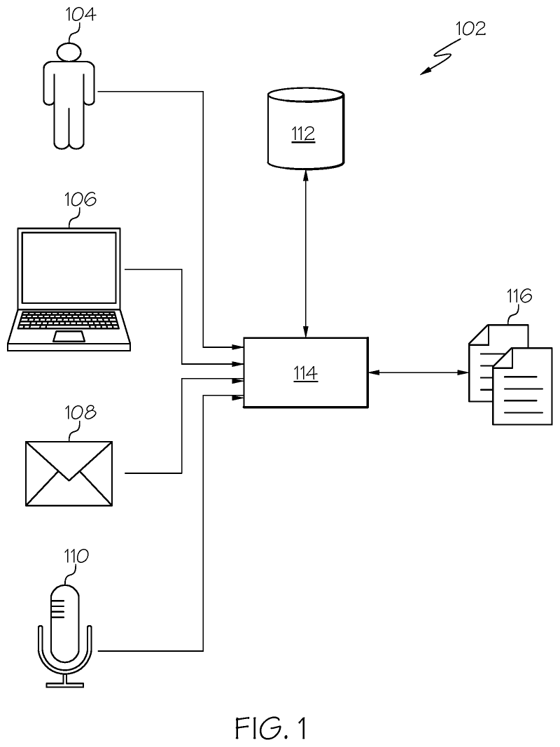

Referring now to FIG. 1, an example system 102 for automatically filling out matter intake forms 116 is schematically illustrated. It should be understood that embodiments are not limited to the configuration of FIG. 1 and that more or fewer elements may be provided. Generally, the system 102 includes various input data sources 104-110 that provide input data to a matter intake form generator 114. As described in more detail below, the matter intake form generator 114 includes one or more trained models to both detect the matter classification and automatically complete one or more matter intake forms 116 based on the input data.

The input data sources may take on a variety of different forms. In the illustrated example, the input data sources include a chat bot 104, a text input 106, an electronic file input 108, and a spoken input 110. These various input data sources provide input data relating to a new matter that has been received into an organization, such as a new legal matter. The input data is used to classify the matter and complete one more matter intake forms 116 relating to the matter. The user may use the one or more input data source to provide information relating to the matter.

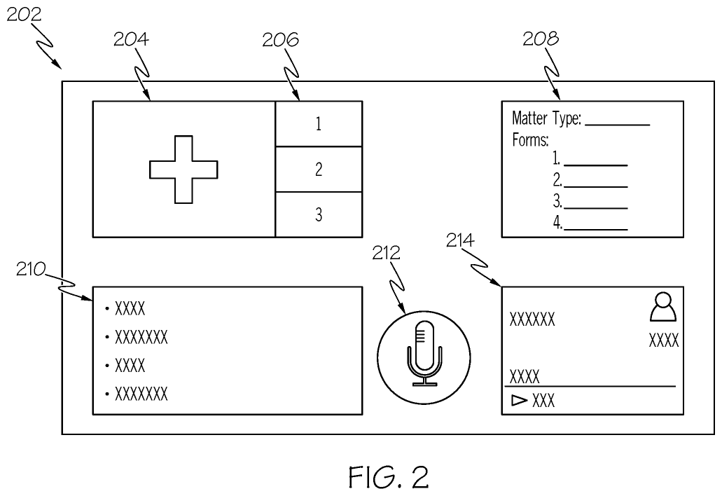

The input data sources 104-110 may be provided in a computer software application that is accessible to the user. FIG. 2 illustrates an example user interface 202 of a software application that is configured to complete matter intake forms 116. The user interface 202 may be a component of a stand-alone software application product, or it may be a plug-in feature of a larger software application tailored to a particular field (e.g., a legal research software program).

The example user interface 202 includes a chat bot interface 214 that provides a chat bot 104 functionality for the user to provide input data regarding the particular matter. The chat bot interface 214 may utilize any known or yet-to-be-developed chat bot model for prompting questions and obtaining information. The chat bot model may be trained on various different matters and to produce relevant questions and statements to elicit the input data from the user. The chat bot 104 may be further trained on historic data, such as previous queries.

The user may ask the chat bot 104 various queries pertaining to a matter, such as legal queries of a legal matter. In the legal context, if the user's query can have its resolution automated by referencing internal legal policy documentation, the user is provided with search results for the given query. When the chat bot 104 identifies that the user is indicating a need to submit a legal request (i.e., user's intended result cannot be automated), it will respond and ask the user to describe the needed legal task.

For example, if the user asks a question regarding elements of submitting a contract request, for example, a non-disclosure agreement, the chat bot 104 may ask for description of what the user needs. The chat bot then supplies an appropriate matter intake form for the user. In some embodiments, the chat bot 104 asks questions of the user relating to information that is still needed to include in a matter intake form.

The user interface 202 also include a file import interface 204 for the user to import electronic files relevant to the new matter. Thus, the file import interface 204 provides an interface for the electronic file input 108 illustrated in FIG. 1. The user may drag-and-drop relevant files into the file import interface 204, or use another means to import the electronic files. Electronic files that are inputted are then listed in an imported files list 206 for review by the user. The user can take various actions regarding the files in the imported files list 206, including opening files, deleting the files, prioritizing the files (e.g., moving them up and down in the list).

As a non-limiting example, one of the electronic files may be an email. The email may be from a client describing a new matter as one example. As another example, the email may be from an organization member to an assistant or the matter intake department that describes the new matter in natural language. For example, the email may include language such as “We received a new patent infringement law suit from Client X where they are being sued by Company Y for alleged infringement of patent No. X0,135,126. The patent is for a dog chew toy . . . . ” As described in more detail below, the matter intake form generator 114 receives the email and uses its text as input data to classify the matter and complete one or more matter intake forms.

Other electronic documents may also be imported using the file import interface 204, such as a legal complaint, other legal documents, company profiles, and the like. These electronic documents may also be used as input data by the matter intake form generator 114.

The user interface 202 of FIG. 2 also includes a text box 210 that is provided for a user to add free-form text regarding the new matter. The user may type in natural language sentences, fragments, words, and the like into the text box 210. No particular formatting is needed. The text box 210 may be used in lieu of the chat bot 104 if the user is familiar with what type of information is needed for the matter intake form generator 114. For example, the user may type in “client: company X; matter: wrongful death; plaintiff: company Y; new client: yes; field: nautical;” and the like into the text box 210. The matter intake form generator 114 receives this data and may use it to classify the matter and complete one or more matter intake forms as described in more detail below.

A microphone button 212 is provided to give the user the ability to use spoken language to provide input data into the system. When the user selects the microphone button 212, the computer software program accesses a microphone of the computer (e.g., desktop computer, laptop computer, smart phone, tablet, and the like). The user can then speak into the microphone (not shown) to describe the new matter that has come in. The user can speak in natural language sentences, or in fragments such as the wrongful death example above, to describe the new matter. The system may include a speech-to-text algorithm to convert the spoken language into text that is then used by the matter intake form generator 114 to classify the new matter and complete the one or more matter intake forms 116.

Referring again to FIG. 1 and as described in more detail below, the matter intake form generator 114 receives input data from one or more input data sources 104-110 and uses it to classify the matter and to complete one or more matter intake forms 116. The matter intake form generator 114 accesses a matter data storage 112 for data relevant to performing its functions, such as historical data, matter data, and any other data needed.

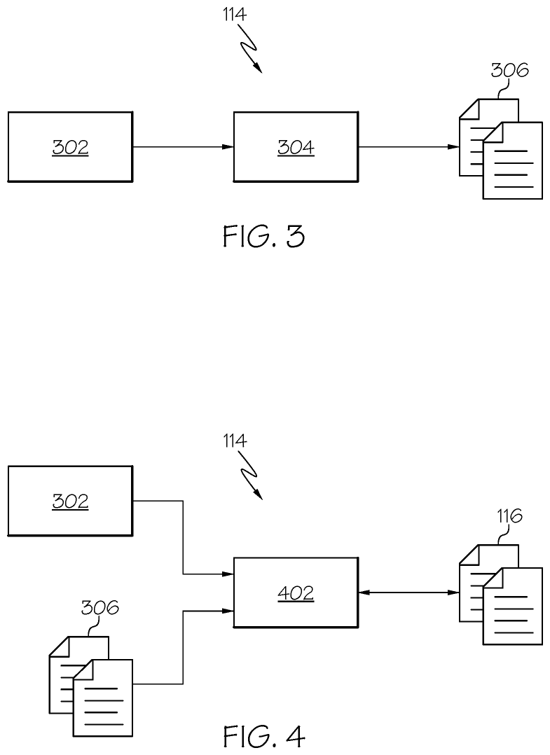

Referring now to FIG. 3, a portion of the system 102 for classifying the matter is illustrated. The matter intake form generator 114 may include a matter classifier 304, which may be a trained classifier that is trained to receive the input data 302 and output a matter classification (e.g., merger, patent infringement, real estate closing, etc.). The matter classifier 304 may be a supervised classifier such as, without limitation, a support vector machine, K-nearest neighbors, Naive Bayes, and logistic regression. The trained classifier is trained to output a matter classification based on input data describing the matter. Embodiments are not limited by the type or number of classifications.

Using the wrongful death example from above, the user may have submitted an email from the client describing the nature of the law suit into the file import interface 204, and also may have inputted various facts regarding the matter into the text box 210, or provided spoken dialogue using the microphone button 212. The trained classifier receives this input data 302 and outputs one or more matter classifications. In this example, the matter is “litigation.” Sub-matters classifications may also be generated, such as “wrongful death,” or a specific matter classifications may be generated, such as “litigation - wrongful death.”

The one or more matter classifications that are outputted by the matter classifier 304 may be displayed in a suggested forms region 208, as shown in FIG. 2. In this way, the user can be confident that the system properly classified the matter. If any changes need to be made, the user may make a change to the matter classification in the suggested forms region 208.

The matter classifier 304 outputs one or more blank matter intake form 306 as shown in FIG. 3. The one or more blank matter intake forms 306 may be listed in the suggested forms region 208. A user can select a listed matter intake form from the suggested forms region 208 to open it, save it, or otherwise interact with it. The user may opt to fill out the one or more matter intake form manually or in some embodiments automatically. There may be a user interface element that the user may select to cause a selected matter intake form to be automatically filled out using field data extracted from the input data.

Referring now to FIG. 4, a portion of the system for automatically filling in (i.e., completing) one or more blank matter intake forms 306 is illustrated. The matter intake form generator 114 includes a field data extractor 402 that is operable to extract field data from the input data and populate the extracted field data into the appropriate fields of the one or more blank matter intake forms 306. In some embodiments, the field data extractor 402 extracts data from the input data 302 by searching its contents for text matching an intake field's predefined formula, then imports that data into the matter type's associated intake form. Each field of the blank matter intake form 306 has a data formula defined for data extraction (for example, a Contract matter type has the intake form field “contract value”. This field's data formula defines the appropriate contents to be of the formats “$xxx,xxx {x=numeric variable}”, “xx,xxx$”, “yyyyyy-yyyyyyyy {y=free text variable} dollars”, etc. Text in the input data 302 matching those criteria is assigned a data type label for extraction).

In other embodiments, the field data extractor 402 comprises a large language model that is operable to receive the input data 302 and the one or more blank matter intake forms 306 or a list of the fields of the one or more blank matter intake forms 306. The system provides a prompt to the large language model for it to extract the fields from the one or more blank matter intake forms 306, and to find field data within the input data 302 that matches the fields. In embodiments where only the fields are provided as input to the large language model rather than the blank matter intake forms 306 themselves, the prompt may be configured to ask the large language model to find the field data within the input data 302 that matches the provided fields. The output of the large language model may be field-field data pairs. The field data extractor 402 may further include a script that takes the field-field data pairs and populates the fields of the one or more blank matter intake forms 306 with the field data extracted from the input data 302.

The end result is one or more populated matter intake forms 116. These forms can be used for downstream purposes, such as, without limitation, providing legal representation, performing medical care based on the data in the matter intake forms 116, creating a work (e.g., a website, an advertisement, an artwork), generating software code (e.g., generating a software program per requirements of the matter intake form), building a structure (e.g., building a house or renovating a building based on requirements of the matter intake form). In some embodiments, the matter intake forms are computer readable and may be automatically transmitted to a machine to autonomously perform an automated physical task, such as an autonomous vehicle that autonomously navigates an environment.

For example, once a matter intake form is completed, the system then submits that completed matter intake form as a matter within the workflow tool for review and assignment. A legal matter may be any inquiry or dispute regarding the rights or obligations of a party in relation to an agreement. In embodiments, legal matter management may refer to a set of activities to be completed a company's legal department. In other embodiments, the system may be used to generate matter forms for any business group and is not limited to legal matters. For example, the system or method may extract data from an email, classify the data for a matter and populate a matter intake form.

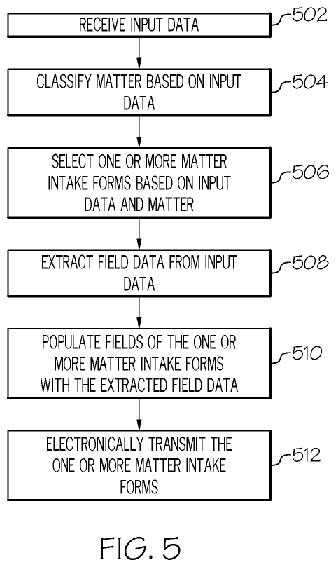

Referring now to FIG. 5, a method for completing one or more matter intake forms is illustrated. At block 502, input data related to a new matter is received by the system. The input data may be generated by any method, such as natural speech, use of a chat bot, imported electronic files, and free text. Next, at block 504 a matter is classified using the input data and a matter classifier of a matter intake form generator 114. From the classified matter, one or more relevant matter intake forms are selected at block 506. These forms may be selected from a repository of forms stored in a data storage device, for example.

At block 508 field data is extracted from the input data. The field data is data that is relevant to fields of the one or more matter intake forms that are selected at block 506. In the legal context, field data may include client name, adverse party NAISC codes, amount at controversy, and the like. A field data extractor is configured to extract the field data from the input that is provided by the user. Next, at block 510 the selected one or more matter intake forms are populated with the field data that was extracted at block 508. Now the system has created populated matter intake forms that are ready for downstream processes, such as transmitting the one or more matter intake forms to desired persons/entities at block 512.

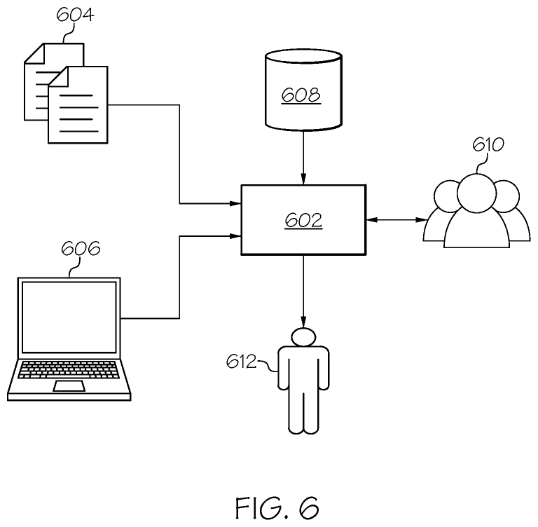

Referring now to FIG. 6, a system for automatically assigning a new matter to an employee or other person for completion of the matter is schematically illustrated. The system includes an assignment engine that is programmed to receive matter information 604 as well as additional rules and constraints from a user device 606. The matter information 604 may include one or more matter intake forms 116 that are completed automatically or manually. The matter information may include any other information relevant to the matter, such as correspondence regarding the matter (e.g., letters, emails, and the like), documents (e.g., legal complaint, project specifications, plans, and the like) and any other information.

The assignment engine 602 creates one or more vectors for the incoming matter information 604. In one example, Doc2Vec is used to create one or more vectors of the matter information 604. The one or more vectors are mathematical representation of documents within the matter information. In some embodiments, a single vector for the entirety of the matter information 604 is created. In other embodiments, a vector is created for each individual document of the matter information 604.

Historical matter documents are stored within a matter database 608. For example, each matter associated with the matter database 608 has a plurality of documents. In a typical project management or docketing system, each matter has a unique identification number and thus documents include an identification number as metadata or are otherwise associated with an identification number. The project management or docketing system includes data regarding the employees that are staffed to a matter. Further, a document management system also embeds metadata representing who authored and worked on a document. Thus, the matter database 608 stores information relating to the people that worked on various matters.

Embodiments are not limited by any number or type of document. The type of document depends on the field of the organization. In the legal context, documents of a particular litigation matter include a complaint, pleadings, expert reports, opinions, and the like. Documents of a legal patent matter may include an invention disclosure form describing an invention, inventor names, due dates, and the like.

The assignment engine 602 (or another component) converts each matter into one or more historical matter vectors. As a non-limiting example, Word2Vec may be used to create the one or more historical matter vectors. As another non-limiting example, a bidirectional encoder representation from transformers (BERT) may be used to generate the vectors described herein. Each historical matter in the matter database 608 may have one historical matter vector, or each document associated with a historical matter may have an individual historical matter vector.

A goal of the system is to recommend an employee who is optimally positioned to handle completion of the incoming matter. An optimal employee is one who has handled similar matters in the past and has the relevant expertise to handle the matter. In embodiments, the assignment engine 602 compares the one or more new matter vectors of the incoming matter information 604 with the plurality of historical matter vectors stored within the matter database 608 to find those historical matters that are most similar to the new matter information 604. Similarity between the one or more new matter vectors and the historical matter vectors may be determined by cosine similarity, for example. Other methods for determining similarity may be utilized. The assignment engine 602 thus generates a list of historical matters that may be ranked according to similarity. In a software development context, a new matter may be for a mobile application for enabling the purchasing of products. Thus, historical matters directed to development of purchasing software would be ranked higher than historical matters relating to development of software for health monitoring. In the legal context, historical matters directed to preparation of mechanical-based patent applications will be ranked higher than historical matters directed to preparation of software-based patent applications.

Each historical matter has one or more employees associated with it. Records regarding who is assigned to a historical matter may be found in the matter database 608, a docketing system, a project management system, a docket management system or any other location. In some embodiments, staffing information is gathered from multiple sources and then indexed and stored in the matter database 608.

The assignment engine 602 may select a subset of historical matters having the highest similarity to the matter information 604. The subset of historical matters may be a top number of historical matters (e.g., top 10) of the ranked list of historical matters, or the historical matters having a similarity value above a threshold.

The organization has a plurality of employees 610 (or other members capable of completing matters) that are to be assigned matters for completion. Having the subset of historical matters, the assignment engine 602 determines the employees associated with the subset of historical matters, which defines a subset of employees. As an example, an index of matter-employee pairs may be searched in the matter database 608 to compile the subset of employees.

In some embodiments, each employee may have an employee profile stored within the matter database 608 or some other storage location. The employee profile stores information regarding the employee, such as which matters the employee has worked on, a total number of matters over a period of time, a number of currently outstanding matters, type of outstanding matters, type of historical matters, client contact names, and expertise.

Embodiments of the present disclosure may further consider workload and other factors when selecting an optimal employee to assign the matter to. These factors may be determined by rules that are set by the user. For example, a user interface may be presented to the user in the user device 606 for generation and/or selection of rules to apply. Thus, embodiments may provide for a rules-based assignment engine with user interface customization. In these embodiments, the user defines various rules, for example, if the matter is an intellectual property matter, it goes to worker ‘X’. In embodiments there may be many intricate rules that are provided.

One example rule is for the assignment engine 602 to consider the workload of each employee of the subset of employees. For example, a user may desire to assign a new matter to an employee that has available bandwidth. In this scenario, if there are any employees with zero matters assigned to them, pick one of those employees as the assigned employee 612. These employees would be in the subset of employees chosen as described above. In some embodiments, if all other factors are equal, an employee is selected out of this group of those having zero matters at random. If all users have at least one matter assigned to them, the assignment engine 602 may determine employees with one matter and select one of them. If there are no employees in the group of those having one current matter assigned, the assignment engine 602 may select an employee from a group of employees that have two matters assigned, and so on until the maximum number of matters that can be automatically assigned is reached. If no employees can be automatically assigned the matter, the assignment engine 602 may return a message.

Other example rules include not assigning matters to employees who have upcoming vacation scheduled, considering assigning matters to employees that are part time, considering years of experience, considering which client contacts an employee has worked with, and the like. Any number of rules may be provided.

In some embodiments, the user interface allows the user to establish weights to be assigned to each rule such that rules having greater importance have higher weights. As a non-limiting example, the user interface may prompt the user to rank the different rules by order of importance, or assign a numerical value regarding importance (e.g., 1 to 10, with 10 being the most important). The assignment engine 602 may then use the weights and the associated rules to calculate a score for each employee in the subset of employees. The employee having the highest score may be automatically assigned the matter as the assigned employee 612. In another non-limiting example, the ranked rules may be applied in a hierarchical manner, with the first rule being applied and, when there are multiple employees that satisfy the rule, the assignment engine 602 may move to the second rule, then the third rule, and so on until there is only one employee remaining.

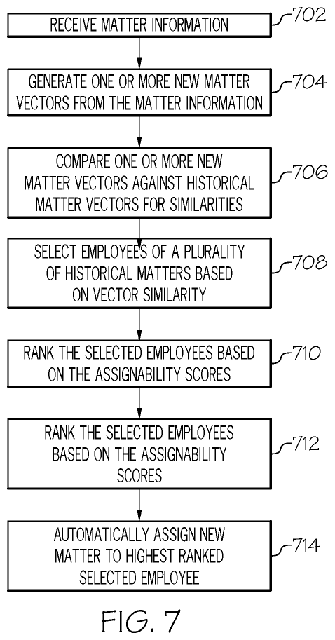

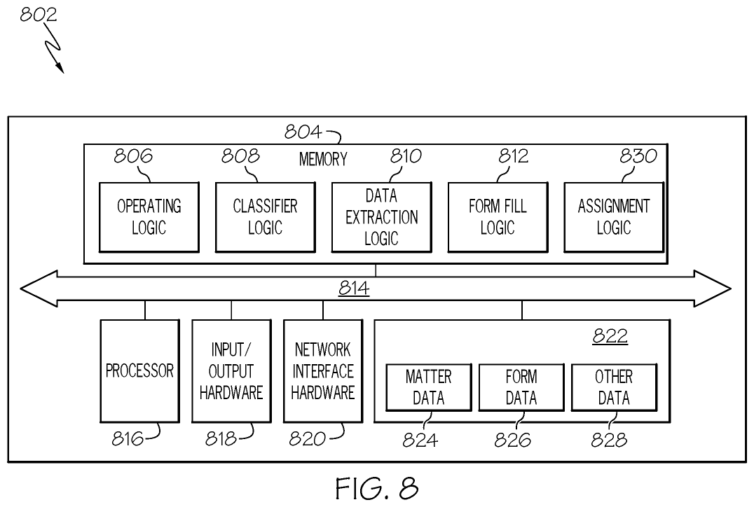

Referring now to FIG. 7, a flowchart illustrating an example method for automatically assigning an incoming matter is provided. At block 702 new matter information is received by the system. The new matter information may be one or more matter intake forms that are generated automatically or manually, as well as any other documents relating to the new matter. At block 704 one or more new matter vectors are generated from the matter information. At block 706 the one or more new matter vectors are compared against historical matter vectors generated from historical matters. Then, a subset of matters having the highest similarity to the one or more new matter vectors is determined, and employees associated with those subset of matters are selected. This subset of employees represents those employees that have worked on previous matters that are most similar to the new matter represented by the matter information. Next, at block 710 one or more rules are applied to the subset of employees to score each employee according to an assignability score, and then rank the employees by assignability score at block 714. The employee having the highest assignability score is then automatically assigned the new matter, such as my automatically sending an email to the employee notifying her that she has been assigned the matter. It is noted that in some embodiment block 712 is not performed, and the rules are applied to select an employee by a process of elimination where a hierarchical order of rules are applied until there is a single employee remaining.

Embodiments of the present disclosure may be implemented by a computing device, and may be embodied as computer-readable instructions stored on a non-transitory memory device. Referring now to FIG. 8, an example system for automatically assigning a matter as a computing device 802 is schematically illustrated. The example computing device 802 provides a system for automatically assigning a matter, and/or a non-transitory computer usable medium having computer readable program code for automatically assigning a matter embodied as hardware, software, and/or firmware, according to embodiments shown and described herein. While in some embodiments, the computing device 802 may be configured as a general purpose computer with the requisite hardware, software, and/or firmware, in some embodiments, the computing device 802 may be configured as a special purpose computer designed specifically for performing the functionality described herein. It should be understood that the software, hardware, and/or firmware components depicted in FIG. 8 may also be provided in other computing devices external to the computing device 802 (e.g., data storage devices, remote server computing devices, and the like).

As also illustrated in FIG. 8, the computing device 802 (or other additional computing devices) may include a processor 816, input/output hardware 818, network interface hardware 820, a data storage component 822 (which may store matter data 824 (e.g., data relating to matter classifications, previous matter data, matter vectors, and the like), form data 826 (e.g., data relating to the various forms), and any other data 828 for performing the functionalities described herein, and a non-transitory memory component 804. The memory component 804 may be configured as volatile and/or nonvolatile computer readable medium and, as such, may include random access memory (including SRAM, DRAM, and/or other types of random access memory), flash memory, registers, compact discs (CD), digital versatile discs (DVD), and/or other types of storage components.

Additionally, the memory component 804 may be configured to store operating logic 806, classifier logic 808 for automatically classifying input data of a new matter into a matter classification, data extraction logic 810 for extracting field data from the input data, form fill logic 812 for filling one or more matter forms with the extracted field data, and assignment logic 830 for determining an assigned employee as described herein (each of which may be embodied as computer readable program code, firmware, or hardware, as an example). It should be understood that the data storage component 822 may reside local to and/or remote from the computing device 802, and may be configured to store one or more pieces of data for access by the computing device 802 and/or other components.

A local interface 814 is also included in FIG. 8 and may be implemented as a bus or other interface to facilitate communication among the components of the computing device 802.

The processor 816 may include any processing component configured to receive and execute computer readable code instructions (such as from the data storage component 822 and/or memory component 804). The input/output hardware 818 may include virtual reality headset, graphics display device, keyboard, mouse, printer, camera, microphone, speaker, touch-screen, and/or other device for receiving, sending, and/or presenting data. The network interface hardware 820 may include any wired or wireless networking hardware, such as a modem, LAN port, wireless fidelity (Wi-Fi) card, WiMax card, mobile communications hardware, and/or other hardware for communicating with other networks and/or devices

Included in the memory component 804 may be the operating logic 806, classifier logic 808, data extraction logic 810, form fill logic 812, and assignment logic 830. The operating logic 806 may include an operating system and/or other software for managing components of the computing device 802. Similarly, the classifier logic 808 may reside in the memory component 804 and may be configured to automatically classify the matter of input data into a matter classification. The data extraction logic 810 also may reside in the memory component 804 and may be configured to automatically extract relevant field data from the input data based on the matter classification. The form fill logic 812 includes logic to automatically fill one or more matter intake forms with the extracted field data. The assignment logic 830 includes logic to determine an assigned employee that is most optimally situated to handle the matter.

The components illustrated in FIG. 8 are merely exemplary and are not intended to limit the scope of this disclosure. More specifically, while the components in FIG. 8 are illustrated as residing within the computing device 802, this is a non-limiting example. In some embodiments, one or more of the components may reside external to the computing device 802.

It should now be understood that embodiments of the present disclosure are directed to systems and methods for automatically assigning a matter (e.g., a work project) by extracting data from electronic matter information and comparing that extracted information with historical matters to select the optimal employee to handle the matter. Upon the creation of a matter, the associated matter information is analyzed along with current employee workloads and other factors to determine who is best suited to completing the matter.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A method of automatically assigning a matter, the method comprising:
receiving, by one or more processors, matter information;
generating one or more new matter vectors from the matter information;
comparing the one or more new matter vectors to historical matter vectors of historical matter information relating to historical matters;
selecting a plurality of historical matters from the historical matters, wherein each historical matter of the plurality of historical matters has a similarity between the one or more new matter vectors and one or more historical matter vectors that is above a threshold;
determining a subset of employees associated with the plurality of historical matters, wherein the subset of employees is a subset of a plurality of employees;
applying one or more rules to the subset of employees to generate a score for each employee of the subset of employees; and
assigning the matter to an assigned employee having a highest score.

2. The method of claim 1, further comprising ranking the plurality of employees based on the scores.

3. The method of claim 1, wherein the matter information comprises a matter intake form that is generated automatically by:
receiving input data from one or more sources, the input data relating to a matter;
classifying, using a trained model, a matter classification based at least in part on the input data;
selecting one or more matter forms based on the matter classification;
automatically extracting field data from the input data; and
automatically populating fields of the one or more matter forms with the extracted field data.

4. The method of claim 3, wherein the trained model is a large language model.

5. The method of claim 3, wherein the trained model is further configured to perform the step of automatically extracting the field data.

6. The method of claim 1, wherein:
the one or more rules are based at least in part on an employee profile of each employee of the plurality of employees; and
wherein the employee profile comprises a total number of matters over a period of time, a number of currently outstanding matters, type of outstanding matters, type of historical matters, client contact names, and expertise.

7. The method of claim 6, wherein the one or more rules prioritizes employees having a lower number of currently outstanding matters.

8. The method of claim 6, further comprising displaying, one an electronic display, a plurality of rules for selection by a user.

9. The method of claim 6, further comprising applying weights to the one or more rules in calculating the score.

10. The method of claim 1, wherein assigning the matter comprises automatically sending an electronic message.

11. A system for assigning a matter comprising:
one or more processors; and
a memory storing instructions that, when executed by the one or more processors, configure the one or more processors to:
receive matter information;
generate one or more new matter vectors from the matter information;
compare the one or more new matter vectors to historical matter vectors of historical matter information relating to historical matters;
select a plurality of historical matters from the historical matters, wherein each historical matter of the plurality of historical matters has a similarity between the one or more new matter vectors and one or more historical matter vectors that is above a threshold;
determine a subset of employees associated with the plurality of historical matters, wherein the subset of employees is a subset of a plurality of employees;
apply one or more rules to the subset of employees to generate a score for each employee of the subset of employees; and
assign the matter to an assigned employee having a highest score.

12. The system of claim 11, wherein the instructions further configure the apparatus to rank the plurality of employees based on the scores.

13. The system of claim 11, wherein the matter information comprises a matter intake form that is generated automatically by:
receiving input data from one or more sources, the input data relating to a matter;
classifying, using a trained model, a matter classification based at least in part on the input data;
selecting one or more matter forms based on the matter classification;
automatically extracting field data from the input data; and
automatically populating fields of the one or more matter forms with the extracted field data.

14. The system of claim 13, wherein the trained model is a large language model.

15. The system of claim 13, wherein the trained model is further configured to perform the step of automatically extract the field data.

16. The system of claim 11, wherein:
the one or more rules are based at least in part on an employee profile of each employee of the plurality of employees; and
wherein the employee profile comprises a total number of matters over a period of time, a number of currently outstanding matters, type of outstanding matters, type of historical matters, client contact names, and expertise.

17. The system of claim 16, wherein the one or more rules prioritizes employees having a lower number of currently outstanding matters.

18. The system of claim 16, wherein the instructions further configure the apparatus to display, one an electronic display, a plurality of rules for selection by a user.

19. The system of claim 16, wherein the instructions further configure the apparatus to apply weights to the one or more rules in calculating the score.

20. The system of claim 11, wherein assigning the matter comprises automatically send an electronic message.
